(19) United States
(12) Patent Application Publication
(10) Pub. No.: US 2017/0238519 A1
(43) Pub. Date: Aug. 24, 2017

(54) Chum Dumpster

(71) Applicants: James Heikkinen, Marquette, MI (US); Sanford Drury, Marquette, MI (US)

(72) Inventors: James Heikkinen, Marquette, MI (US); Sanford Drury, Marquette, MI (US)

(21) Appl. No.: 15/051,303

(22) Filed: Feb. 23, 2016

(51) Int. Cl. A01K 97/02

(52) U.S. Cl. CPC A01K 97/02

(57) ABSTRACT

The present invention provides a chum dispenser that could be used to dispense chum under water and at desired depth. The chum dispenser allows dispensing the chum in a concentrated area under the water, which is desired for luring fish. The chum dispenser comprises a container with a snap-fit lid. The container is further coupled to the lid through a rigid line such that the container and lid are movable with respect to each other in open state and the container could turn over to dispense the chum. The dispenser is suspended through a flexible line, which could be jerked by hand to open the lid of dispenser and dispense the chum in water.

### BACKGROUND OF THE INVENTION

(1) Field of Invention

The present invention generally relates to an underwater chum dispenser, and in particular, to a chum dispenser that dispenses chum under the water and in a concentrated manner.

(2) Background of Invention

The use of chum or bait to attract fish to an area of water has been known for generations. Generally, a container containing chum is tossed over water surface near the edge of the boat and the chum either floats or sinks. However, the method of dispersing chum over the water has several disadvantages, such as the water currents causes the chum to disperse over a larger area and the diluted chum is less effective to attract the fish to a concentrated area. Moreover, the dispersed chum sinks slowly and the water current carries away most of the chum before the chum could reach the desired depth. Thus, it is desirable to have an apparatus that allow dispersing the chum under the water and in a more concentrated manner.

Prior arts disclosing an apparatus for dispersing chum under the water includes a U.S. Pat. No. 5,131,183 issued to “Timothy Thayer et. al.” a U.S. Pat. No. 3,163,959 issued to “Hollar George E”; a U.S. Pat. No. 6,138,400 issued to “Todd A. Gervae”; a U.S. Pat. No. 6,513,279 issued to “Carlos Hernandez”. Beside, several types of apparatus are known in the prior art for dispersing chum under the water, a need for an improved device that could sink easily to desired depth and releases chum as and when desired in a concentrated manner could be appreciated.

### SUMMARY OF THE INVENTION

The present invention, therefore, has as its principal object to provide a chum dispenser that could dispense chum under the water.

Another object of present invention is that the chum dispenser disperses chum at desired depth.

Still, another object of present invention is that the chum dispenser releases chum in a concentrated manner.

An additional object of present invention is that the chum dispenser could easily sink to desired depth.

A further object of present invention is that the empty dispenser could be easily retracted and reused.

A still further object of present invention is that the chum dispenser could carry significant amount of chum.

Yet another object of present invention is that the chum dispenser is economic to manufacture and easy to use.

Certain embodiments of present invention provide a chum dispenser that could be used to dispense chum under the water at desired depth. The chum dispenser comprises a cylindrical container having a closed bottom, an open top and a wall. The closed bottom and the wall defines volume of the container; a lid adapted to snap-fit on the open top of the container in a sealable manner; the lid having a top surface and a bottom surface; two eye hook swivably coupled (the hooks are coupled such that the hooks could be freely rotated with respect to the container) to the bottom edge of the wall of container at opposite sides; a rigid line with curved ends forming a hook, passes along the top surface of the lid along the diameter of the lid and the rigid line is fixed to the top surface of the lid; the rigid line is curved down at opposite ends of lid and passes through the eye of hooks. In open state, the lid and container are movable with respect to each other and the container could turn over with the both eye hooks supported on the curved hooks of the rigid line. A flexible line, such as a rope could be coupled to the lid and used to suspend the chum dispenser in water. The flexible line could be jerked to open the lid, and the container could turn over to release the chum in water.

In another embodiment, the wall of the container comprises number of holes allowing water to enter the container. The water replaces the air inside the container allowing the dispenser to easily sink. Moreover, additional weights could be coupled to the dispenser to allow the dispenser to sink easier, particularly in stronger water currents. The chum dispenser could be manufactured in different sizes for carrying different volumes of the chum.

In addition to the various objects and advantages of the present invention described with some degree of specificity above it should be obvious that additional objects and advantages of the present invention will become more readily apparent to those persons who are skilled in the relevant art from the following more detailed description of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is side perspective view of chum dispenser.

FIG. 2 is the side view of chum dispenser in inverted state.

FIG. 3A is the side perspective view of chum dispenser of different lid size.

FIG. 3B shows the chum dispenser of FIG. 3A having the lid removed.

### DETAIL DESCRIPTION OF THE INVENTION

The present invention provides a chum dispenser for dispensing the chum under water and at desired depth in a concentrated area.

Before explaining at least one embodiment of the invention in detail, it is to be understood that the invention is not limited in its application to the details of construction and the arrangements of the components set forth in the following description. The invention is capable of other embodiments and of being practiced and carried out in various ways. In addition, it is to be understood that the phraseology and terminology employed herein are for the purpose of description and should not be regarded as limiting.

As used in this specification and the appended claims, the singular forms “a”, “an”, and “the” include plural referents unless the content clearly dictates otherwise.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

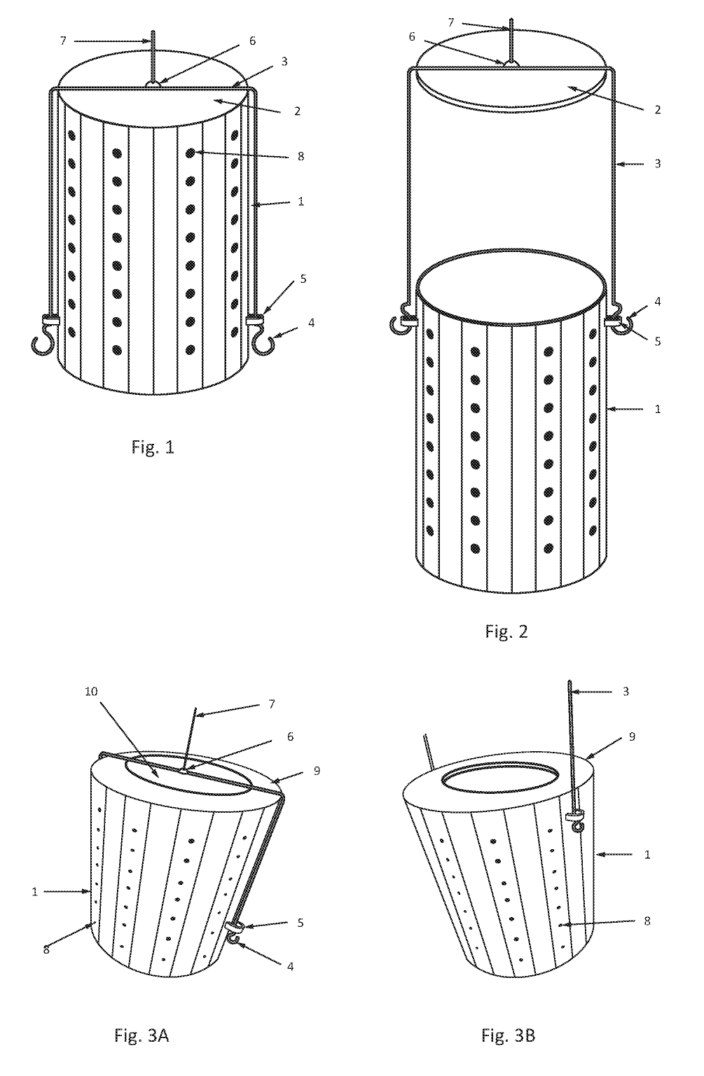

Referring to FIG. 1, the present invention is a chum dispenser used for dispensing the chum under the water. The dispenser containing the chum could sink in water up to the desired depth and opened to release the chum in water. The chum is released in a concentrated area under the water, which is desired for luring the fishes. The dispenser as referred in FIG. 1 includes a container 1, which is similar to a cylindrical body and has a closed bottom, sides and an open top. On top of the container is a lid 2 configured to snap fit on the open top of the container. The lid tightly closes the open top of the container, such that the dispenser when suspended in closed state, the lid remains secured to the container, but could open by jerking the rope through which the dispenser is suspended.

On the bottom edge of the wall of the container are coupled two eyehooks 5 on opposite sides of the container. The hooks are similar to eye screw having a ring portion and coupling portion. The hooks are swivably coupled to the container such that the eye of the hooks could be freely rotated with respect to the container. The types of swivel joint and their use are obvious to a skilled person. Further shown in FIG. 1, a rigid line 3 is fixed to the top surface of the lid and passes through center of the lid. The rigid line could be made of materials, such as metal or plastic and coupled to the top surface of the lid through clamp or any other means obvious to a skilled person for attaching a rigid line to a plain surface. The rigid line is curved downwards at both ends along the edges of the lid and passes through eye of the hooks 5. Both the ends of rigid line are curved to form hook shape 4.

The dispenser could be suspended through a flexible line 7, which could be a rope or a fishing pole. The flexible line could be coupled to the lid of the container and in FIG. 1, the flexible line is coupled to the rigid line through an eye hook 6.

The lid and the container in open state are movable with respect to each other and held together through the rigid line. In open state of the dispenser, the container could turn over through the hooks 5 to an inverted position as shown in FIG. 2. The dispenser containing the chum with lid firmly secured could be suspended in the water through the flexible line, such as a rope. The dispenser could be allowed to sink to the desired depth. For dispensing the chum, the suspending rope could be jerked by hand, which causes the lid to open, and the container is inverted and suspended on the rigid line at hooks. The container could freely rotate through the hook and the weight of the chum causes the container to turn over and dispense the chum in a concentrated manner. The empty dispenser could be retracted and reused.

The wall of the dispenser could have number of holes as shown in FIGS. 1 & 2. The holes 8 cause the water to enter the dispenser and replace any air inside the dispenser, when suspended in water. This allows the dispenser to sink easily in the water. Moreover, additional weights could also be added to the dispenser to allow the dispenser to sink more easily, particularly in presence of strong water currents. The dispenser could be made of any material, such as plastic or metal. Preferably, the material should be rust resistant or an antirust coating could be applied to the dispenser. The chum dispenser could be manufactured in different sizes to carry different volumes of the chum.

The chum dispenser could further include lightning mechanism, such as, LED's. The LED could be places in base, lid or any other outer surface of the chum dispenser. Further, suitable power source, such as replaceable batteries, rechargeable batteries etc. could also be used. The lights and batteries could be water sealed to prevent any damage to due to water. The use of lightning could be advantageous in fishing as a lure, and could provide enhanced visibility of the chum dispenser in dark conditions or under water.

Further, shown in FIGS. 3A & 3B, the lid could be of different design having a flange portion 9 or outer lid and an inner snap fit lid 10. The outer lid could be removably coupled to the open top of the container such as through screw mechanism or using clips. The inner circumference of the outer lid defining an opening through which the chum could be dispensed have a snap fit mechanism and the inner lid is configure to removably couple to the outer lid through snap fit mechanism. The rigid line is coupled to the inner lid, such that on snapping the flexible line, the inner lid can open to dispense the chum. Such a mechanism could be advantageous in large size dispensers having big lid and in case the snap fit mechanism fails, only the lid have to be replaced.

It is to be understood that the chum dispenser encompasses a variety of alternatives. For example, the container may include a variety of shapes apart from the cylindrical shape as shown in the drawing and in addition, the dispenser can be produced in different sizes. Similarly, the lid could be produced in different designs such as shown in FIGS. 1 & 3. Moreover, different material could be used in making the chum dispenser, for example, the rigid line could be made of metal or plastic. Similarly, the container could be made of metal or plastic. In addition, the flexible line could be a rope made of nylon or any other material. The shape and number of holes in the container could be varied. The chum dispenser could be sold with a prepacked chum wherein the chum dispenser could be disposable or reusable. Moreover, the snap fit mechanism of closing the lid on the container could be replaced by any other mechanism obvious to a skilled person without departing from the scope of present invention. Furthermore, the chum dispenser may include various forms of indicia and color.

Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

We claim:

1. A chum dispenser for use in dispensing chum under the water, said chum dispenser comprising:
a. a cylindrical container having a closed bottom, a wall and an open top, the closed bottom and the wall defining volume of the container, the wall having plurality of holes;
b. a lid configured to close the open top of said container in a snap fit manner; said lid having a top surface and a bottom surface;
c. two eye hook swivably coupled to the bottom edges on opposite sides of the container;
d. a rigid line extending along the diameter of said lid and fixed to the top surface of the lid, the rigid line curves downwards at both ends along the edge of the lid, said lid passes through the eye of said eye hooks; the both ends of the rigid line curves to form a hook shape;
e. a flexible line coupled to the lid, said flexible line is used to suspend the chum dispenser;
said lid is tightly secured to the open top of the container but could open when the flexible rope coupled to the lid is jerked by hand, in open state the lid and the container are movable with respect to each other and the container could turn over to release the chum.

2. The chum dispenser of claim 1, wherein the empty chum dispenser could be retracted and reused.

3. The chum dispenser of claim 1, wherein said chum dispenser further comprises additional weight coupled to said dispenser.

4. The chum dispenser of claim 1, wherein said flexible line is a rope.

5. The method of dispensing chum under the water and at desired depth using a chum dispenser, wherein said chum dispenser comprises:
a. a cylindrical container having a closed bottom, wall and an open top, the closed bottom and wall defining the volume of the container, the wall having plurality of holes;
b. a lid configured to close the open top of said container in a snap fit manner; said lid having a top surface and a bottom surface;
c. two eye hook swivably coupled to the bottom edges on opposite sides of the container;
d. a rigid line extending along the diameter of said lid and fixed to the top surface of the lid, the rigid line curves downwards at both ends along the edge of the lid, said lid passes through the eye of said eye hooks; the both ends of the rigid line curves to form a hook shape;
e. a flexible line coupled to the lid, said flexible line is used to suspend the chum dispenser;
said lid is tightly secured to the open top of the container but could open when the flexible rope coupled to the lid is jerked by hand, in open state the lid and the container are movable with respect to each other and the container could turn over to release the chum.

6. The method of claim 5, wherein the empty chum dispenser could be retracted and reused.

7. The method of claim 5, wherein said chum dispenser further comprises additional weight coupled to said dispenser.

8. The method of claim 5, wherein said flexible line is a rope.
